(19) United States
(12) Patent Application Publication
(10) Pub. No.: US 2024/0011555 A1
(43) Pub. Date: Jan. 11, 2024

(54) SPEED REDUCER WITH GAP COMPENSATION FOR ELECTRIC POWER STEERING

(71) Applicant: JTEKT EUROPE, Irigny (FR)

(72) Inventors: Philippe SIZUN, Pont Eveque (FR); Roch MONNET, Brindas (FR); Fabien MULAS, Chaponay (FR); Philippe CHAUVRAT, Villeneuve (FR); Arnaud DURILLON, Longes (FR)

(73) Assignee: JTEKT EUROPE, Irigny (FR)

(21) Appl. No.: 18/220,559

(22) Filed: Jul. 11, 2023

(30) Foreign Application Priority Data
Jul. 11, 2022 (FR) 2207095

(51) Int. Cl. F16H 57/12; F16H 1/16; F16H 57/00; B62D 5/04; B62D 5/00

(52) U.S. Cl. CPC F16H 57/12; F16H 1/16; F16H 57/0006; B62D 5/0409; B62D 5/0403; B62D 5/0421; B62D 5/006; F16H 2057/127

(57) ABSTRACT

A speed reducer includes: a case, a worm disposed in a housing of the case and including a proximal portion coupled to an input shaft, a worm wheel coupled to an output shaft and arranged so as to be driven in rotation by the worm, a proximal bearing holding the proximal portion of the worm in the housing, a distal bearing holding a distal portion of the worm, the distal bearing being disposed in a cylindrical distal portion of the housing, a spring held fixed in the distal portion of the housing around the distal bearing, the spring including at least one elastic blade disposed and shaped to bear on the case and to exert forces on the distal bearing in a direction towards the worm wheel.

### TECHNICAL FIELD

The present invention concerns the field of electric power steering for motor vehicles, and more particularly the speed reducer making it possible to transmit the torque produced by an electric assistance motor to the mechanical steering link connecting the steering wheel of the vehicle to the steered wheels.

### STATE OF THE ART

An electric power steering system for a motor vehicle generally includes a mechanical part comprising a steering wheel linked in rotation to a steering column, the end of which that is remote from the steering wheel carries a steering pinion engaged with a rack, slidably mounted in a steering case. The two opposite ends of the rack are respectively linked, via rods, to the right and left steering wheels of the vehicle. To assist the manual effort exerted by the driver of the vehicle on the steering wheel, such a steering system comprises an electric assistance motor with two rotational directions, the output shaft of which is coupled, by means of a speed reducer to the mechanical steering link between the steering column and the steered wheels of the vehicle, so as to transmit a motor torque (possibly also a resistive torque) for assistance to the steering column. The electric assistance motor is controlled by an on-board electronic computer, which receives and processes various signals, coming from sensors including in particular a sensor of torque exerted on the steering column by the driver of the vehicle.

There are various known speed reducer devices, in particular provided with worm and worm wheel. Japanese patent application No. JP2006-117049 describes a worm speed reducer including a gap compensation spring that includes elastic blades. The spring is shaped to clips onto a bearing of the worm located on the side opposite to the motor and moves with it, inside an oblong housing machined in the case accommodating the speed reducer. The housing is closed with a waterproof plug. The elastic blades are arranged to hold the worm against the worm wheel, and thus compensate the gap between the worm and the worm wheel. This gap is due in particular to geometric dispersions inherent in the manufacture of mechanical components, to temperature variations, and to normal operating wear. The portion of the case accommodating the spring has a complex, oblong shape with a cavity to accommodate the elastic blades. This complex shape can only be obtained by an additional machining operation that is complex, long, and requiring very high precision of shape and positioning, compared to the other machining operations necessary to form the housing of the speed reducer within the case.

It is therefore desirable to be able to provide a worm speed reducer that can reduce the noise and vibrations of the shock and rattle type (“backlash/rattle noise”) generated when driving on uneven ground (cobblestones, uneven road, road joints, etc.) or during a reversal steering. It is also desirable to be able to reduce the number of parts, the complexity of the machining, and the size of such a speed reducer, while increasing its service life.

### SUMMARY OF THE INVENTION

Embodiments relate to a speed reducer comprising: a case, a worm disposed in a housing of the case and including a proximal portion coupled to an input shaft, a worm wheel coupled to an output shaft and arranged so to be driven in rotation by the worm, a proximal bearing holding the proximal portion of the worm in the housing, a distal bearing holding a distal portion of the worm, the distal bearing being disposed in a cylindrical distal portion of the housing, a spring held fixed in the distal portion of the housing around the distal bearing, the spring comprising at least one elastic blade disposed and shaped to rest on the case and to exert forces on the distal bearing in a direction towards the worm wheel.

Thanks to these arrangements, the spring is fixed in the case and the distal bearing moves in the spring. Thus, the friction and the wear of the housing due to the displacements of the spring or of the bearing in the housing, generally made of aluminum, are reduced. Friction occurs mainly between the spring and the distal bearing which are generally made of steel, the coefficient of friction between two steel parts being relatively lower than the coefficient of friction of a steel part on an aluminum part. In addition, it is possible to eliminate the side gap between the spring and the distal bearing, by varying the shape and the flexibility of the spring.

Furthermore, the distal portion of the housing on the spring side has a cylindrical shape, which is therefore easy to manufacture. Consequently, the machining of the distal portion of the housing can be carried out in the same operation as the machining of the housing of the proximal bearing on the motor side, and therefore without having to open the distal portion of the housing to carry out this machining. It can thus be ensured that the two bearings are perfectly coaxial. Such non-through machining makes it possible to save a plug, a possible joint and assembly operations thereof.

If the space between the spring and the case is small, the two blades are caused to deform only slightly without exceeding their elastic limit.

In the event that the speed reducer or the input and output shafts may be subject to shocks, these arrangements make it possible to reduce the noise or vibrations of the type of shock and rattling noises generated in the speed reducer, when driving on uneven ground or during a reversal steering.

According to one embodiment, the spring comprises a protrusion provided so as to be engaged in a recess formed in the distal portion of the housing, in order to block the spring in rotation in the housing.

Thus, the locking in rotation of the spring in the case can be achieved simply, without requiring complex machining.

According to one embodiment, the protrusion has a U-shape extending radially outwardly of the spring.

Thus, the direction of action of the blades can be easily changed, by changing only the position of the protrusion on the spring. Indeed, the change of this direction can be useful to carry out adaptations of the reducer according to geometrical reducer characteristics, such as the intersecting angle, the helix angle, and the pressure angle.

According to one embodiment, the spring comprises flat side portions disposed and shaped to guide the distal bearing in the direction towards the worm wheel and in an opposite direction, and eliminate a side gap between the spring and the distal bearing. In this way, the worm can be held precisely in a median plane of the worm wheel and thus prevent an error in the intersection angle which would be detrimental to the quality of the mesh. In addition, the elimination of such a gap helps to reduce the noise likely to be generated in the event of shocks caused to the reducer and the input and output shafts.

According to one embodiment, the flat side portions are extended radially inwardly of the spring by tabs cooperating with the distal bearing to block the spring axially in a distal direction.

Thus, the axial retaining tabs of the spring on the distal bearing can be formed by bending of protrusions extending the flat areas of the annular portion of the spring, without affecting the cylindrical shape of the major portion of the spring. The presence of the tabs extending the flat portions also makes it possible to stiffen these latter.

According to one embodiment, each elastic blade has a curvature and a variable width between its fixed end and its free end, adjusted so as to obtain a curve of variation of the force exerted by the blade on the distal bearing as a function of a position of the distal bearing in the spring.

Thus, impact noise can be reduced by adjusting the shape and curvature of each elastic blade.

According to one embodiment, the curve of variation of the force exerted by each elastic blade on the distal bearing as a function of a position of the distal bearing in the spring is linear with a relatively low slope, then more rapidly increasing in the vicinity of an end of stroke of the distal bearing in the direction towards the worm wheel.

According to one embodiment, the spring comprises an annular portion extending over an angular sector comprised between 240° and 300°, each elastic blade having a free end and a fixed end secured to the annular portion.

According to one embodiment, the spring comprises two elastic blades having a width lower than a height of the spring and arranged so as to intersect in an area diametrically opposite to a contact area between the worm and the worm wheel.

In this way, the contact forces exerted by the spring on the distal bearing are balanced and oriented in the direction of the worm wheel.

Embodiments may also relate to a power steering for a motor vehicle, the power steering comprising a speed reducer coupled between an assistance motor and a rotary member of a steering system of a motor vehicle, the speed reducer being as previously defined.

According to one embodiment, the worm wheel of the speed reducer is secured to a steering column of the steering system.

According to one embodiment, the worm wheel of the speed reducer is secured to a pinion shaft coupled to a rack pinion of the steering system.

According to one embodiment, the worm wheel of the speed reducer is secured to a pinion shaft coupled to an additional rack pinion of the steering system.

According to one embodiment, the worm wheel of the speed reducer is secured to a force feedback steering column of a steering system without any mechanical link between a steering wheel and steered wheels of the motor vehicle.

According to one embodiment, the power steering comprises another worm speed reducer and worm wheel, the worm wheels of the speed reducer and of the other speed reducer being coupled respectively to rack pinions of the steering system.

### BRIEF DESCRIPTION OF FIGURES

The present invention will be better understood through the following description with reference to the appended figures, in which identical reference signs correspond to structurally and/or functionally identical or similar elements.

FIG. 1 is a schematic view of a conventional motor vehicle steering system, equipped with an electric assistance,

FIG. 2 is a schematic view of another conventional motor vehicle steering system, equipped with an electric assistance,

FIG. 3 is a schematic view of another conventional motor vehicle steering system, equipped with an electric assistance,

FIG. 4 is a schematic view of another motor vehicle steering system, equipped with an electric assistance,

FIG. 5 is a schematic view of another motor vehicle steering system, equipped with an electric assistance,

FIG. 6 is a schematic sectional view of a conventional worm speed reducer,

FIG. 7 is a cross-sectional view of a gap compensation spring used in the speed reducer of FIG. 6, according to the prior art,

FIG. 8 is a schematic longitudinal sectional view, of a worm speed reducer, according to one embodiment,

FIGS. 9A and 9B are schematic cross-sectional views of the worm speed reducer, showing a gap compensation spring, respectively without and with the worm, according to one embodiment,

FIG. 10 is a schematic side view of the gap compensation spring, according to one embodiment,

FIG. 11 is a schematic perspective view of the gap compensation spring, according to one embodiment,

FIG. 12 is a schematic perspective view of the gap compensation spring, according to one embodiment,

FIG. 13 is a schematic perspective view of a portion of the gap compensation spring, according to one embodiment,

FIG. 14 is a schematic perspective view of a portion of the gap compensation spring, according to one embodiment.

### DETAILED DESCRIPTION

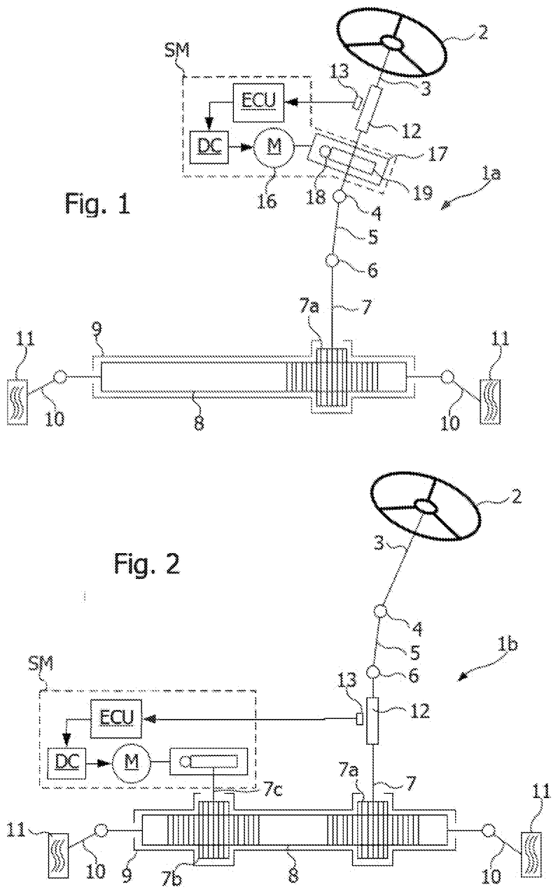

FIGS. 1, 2 and 3 represent motor vehicle steering devices 1a, 1b, 1c equipped with an electric assistance device, according to the prior art.

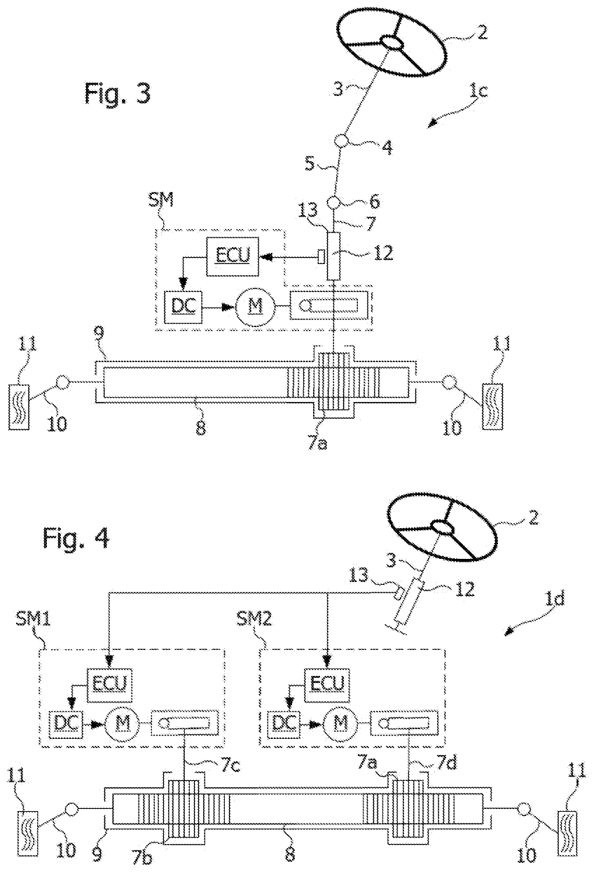

FIG. 1 represents a power steering 1a of the type column C-EPS (“Column type—Electric Power Steering”). FIG. 2 represents a power steering 1b of the type dual pinion DP-EPS (“Dual Pinion—EPS”). FIG. 3 represents a power steering of the type P-EPS (“Pinion type—EPS”). Each of the devices 1a, 1b, 1c comprises a steering column 3 coupled to a steering wheel 2, an intermediate shaft 5 coupled to the steering shaft 3 by means of a dial joint 4. The intermediate shaft 5 is connected to a steering pinion 7a by means of a dial joint 6 and a pinion shaft 7. The steering pinion 7a is engaged with a rack bar 8, slidably mounted in a steering case 9. The two opposite ends of the rack bar 8 are respectively linked, by means of rods 10, to the right and left steering wheels 11. When the steering wheel is actuated in rotation, the steering column is driven in rotation. This rotation is converted into translational motion by the rack bar 8 which turns the wheels 11.

To assist the manual effort exerted by the driver of the vehicle on the steering wheel 2, each of the power steering devices 1a, 1b, 1c comprises a motor system SM comprising an electric assistance motor M with two rotational directions and a speed reducer 17. The output shaft of the motor M is coupled, by means of the speed reducer 17 to the power steering of the vehicle, so as to transmit a motor torque (possibly also a resistive torque) to the steering. The motor system SM also comprises a control unit (on-board electronic computer) ECU, which receives and processes various signals from sensors and in particular a torque sensor 13 and supplies control signals to a control circuit DC of the engine M. The speed reducer 17 may be of the type comprising a worm formed by a worm shaft 18 and a worm wheel 19 secured to the power steering of the vehicle. The torque sensor 13 comprises for example a torsion bar 12 interconnecting an upstream portion to a downstream portion of a vehicle steering shaft. A motion detector 13 coupled to the torsion bar 12 provides a measurement of the relative rotational movement between the upstream and downstream portions of the steering shaft on either side of the torsion bar 12.

In a power steering device of the C-EPS type (FIG. 1), the worm wheel 19 of the speed reducer 17 is secured to the steering column 3, and the torsion bar 12 is interposed between an upstream section and a downstream section of the column 3.

In a power steering device of the DP-EPS type (FIG. 2), the worm wheel 19 of the speed reducer 17 is secured to a shaft 7c coupled by another pinion 7b to the rack bar 8. The torsion bar 12 is interposed between an upstream section and a downstream section of the pinion shaft 7.

In a power steering device of the P-EPS type (FIG. 3), the worm wheel 19 of the speed reducer 17 is secured to the pinion shaft 7, and the torsion bar 12 is interposed between an upstream section and a downstream section of the pinion shaft 7.

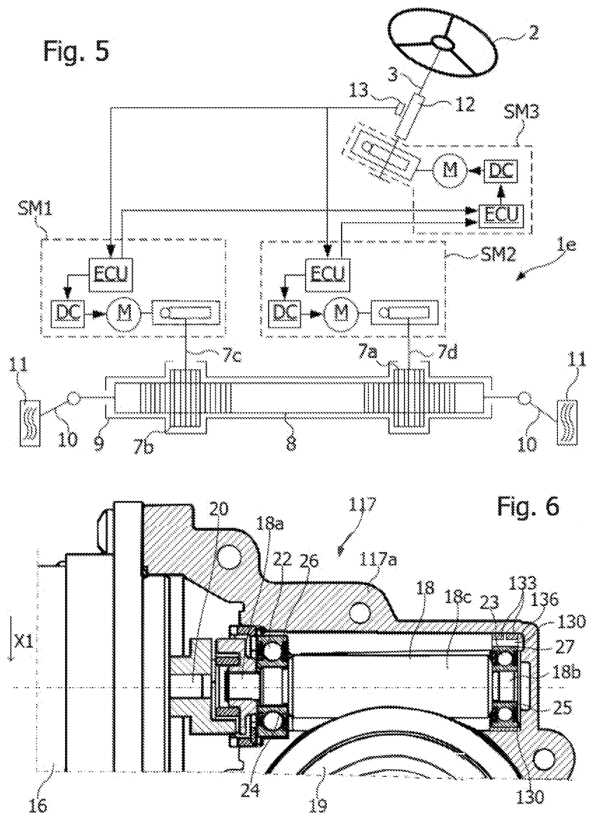

FIGS. 4 and 5 represent other motor vehicle steering devices 1d, 1e equipped with an SBW (“Steer by Wire”)-type electric assistance device. In these two devices, the steering wheel 2 is no longer mechanically coupled to the rack bar 8, but by means of two motor systems SM1, SM2 which can be identical to the previously described motor system SM. The motor systems SM1, SM2 are mechanically coupled to the rack bar 8 respectively by shafts 7c, 7d and pinions 7a, 7b. The torque sensor 13 is associated with the steering column 3, the control units ECU of the systems SM1, SM2 both receiving the signals from the sensor 13.

The device 1e (FIG. 5) comprises a third motor system SM3 coupled to the steering column 3 to supply a resistive torque or a motor torque to the steering wheel 2. The control unit ECU of the system SM3 is connected to the control units ECU of the systems SM1, SM2 to provide force feedback on the steering wheel 2 according to the control signals generated by the systems SM1, SM2.

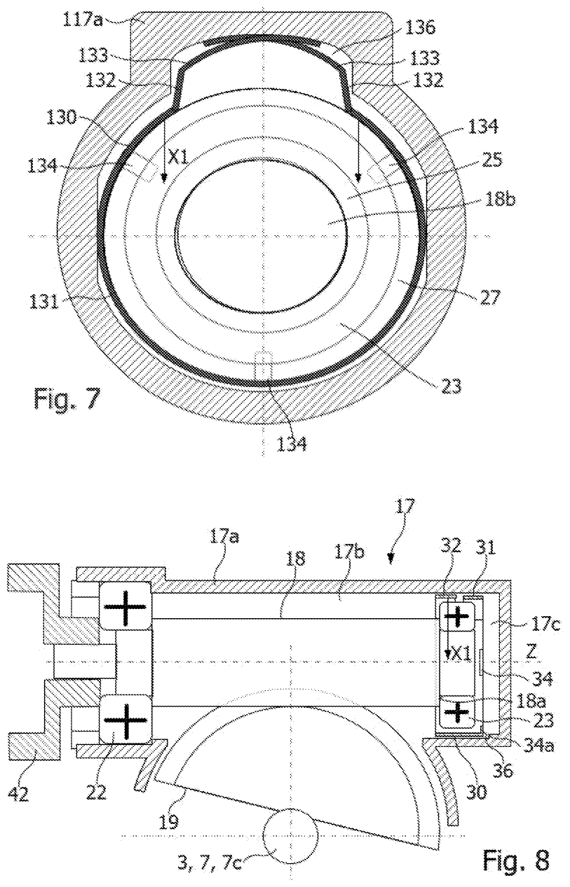

FIG. 6 shows in more detail a worm speed reducer 117 with worm wheel 19 and worm 18, according to the prior art. The speed reducer can be mounted on the steering column 3 (FIG. 1), on an additional pinion 7b (FIGS. 2, 4, 5) or on the pinion shaft 7 (FIG. 3). The worm shaft 18 is disposed coaxially and coupled to an output shaft 20 of the electric motor M so that the mechanical power supplied by the motor is transmitted to the shaft 18 by causing the latter to rotate around its axis. The shaft 18 coupled to the motor M comprises a proximal end portion 18a, and a distal end portion 18b linked by a central portion 18c. The central portion 18c is provided with teeth (not represented) arranged to mesh with teeth of complementary shape provided on the periphery of the wheel 19, secured to the steering column 3 and coaxial therewith. The end portions 18a, 18b of the shaft 18 are held in the case 117a of the reducer 117 by a proximal bearing 22 and a distal bearing 23, for example of ball or roller bearing type. The bearings 22, 23 each comprise an inner ring 24, 25 in contact with one of the end portions 18a, 18b of the shaft 18, and an outer ring 26, 27. The ring 26 of the proximal bearing 22 is fixed in the case, while the ring 27 of the distal bearing 23 can move linearly within the case 117a to follow the movements of the worm 18. The distal bearing 23 is held in a housing of the case 117a via a gap compensation spring 130. The spring 130 comprises curved elastic blades 133 accommodated in a cavity 136 formed in the periphery of the housing accommodating the outer ring 27 of the distal bearing 23. Thus, the elastic blades 133 push the distal bearing 23 in the direction X1 (indicated in FIGS. 6 and 7) of wheel 19.

FIG. 7 represents the spring 130. The spring 130 includes an annular portion 131 surrounding a major portion of outer ring 27 of distal bearing 23, and the spring blades 133. Tabs 134 extending radially from proximal and distal edges of the annular portion of the spring 130 make it possible to hold the spring 130 on the outer ring 27 of the distal bearing 23. The elastic blades 133 each have a free end and an end connected to a respective side edge of the annular portion 131 by abutment portions 132. The elastic blades 133 and the abutment portions 132 are accommodated in the cavity 136 formed within the case 117a of the reducer 117. The spring 130 is for example formed in a spring blade by bending and/or stamping. The abutment portions 132 are shaped so as to cooperate with the inner wall of the cavity 136, in order to prevent rotation of the spring 130 in the case 117a. The elastic blades 133 are shaped so that their free ends bear on the bottom of the cavity 136 and push the bearing 23 towards the worm wheel 19. The elastic blades 133 are arranged so as to intersect in the vicinity of their respective free ends at the bottom of the cavity 136. The elastic blades 133 thus form a mechanism for compensating the meshing gap of the reducer 117 provided with a worm wheel 19 and a worm 18. This gap compensation makes it possible to absorb the geometric dispersions inherent in the manufacture of the parts constituting the reducer 117, temperature variations, normal operating wear, etc.

However, the housing of the reducer in the case 117a of oblong shape along an axis defined by the direction X1 and with the cavity 136, is machined in an additional, long operation (contouring), requiring very high precision of shape and of positioning compared to another type of machining of the case 117a.

After assembly, the housing of the reducer in the case 17a must be obturated, and in a tightly sealed manner, in particular for systems that must be mounted under the cover, such as the P-EPS and DP-EPS systems.

FIG. 8 represents a speed reducer 17 provided with a worm 18 and a worm wheel 19, according to one embodiment. The reducer 17 differs from the reducer 117 in that the spring 130 is replaced by a spring 30 and in that the case 117a is replaced by a case 17a. FIG. 8 shows the worm 18 and the worm wheel 19 mounted in a housing of the case 17a. The worm wheel 19 is secured to the steering column 3 and mounted coaxially to the latter. The worm 18 is held within the case 17a by the proximal bearing 22 and the distal bearing 23 and coupled to the shaft of the motor M by a coupling member 42. The distal bearing 23 is guided in the case 17a by the spring 30 which is shaped to exert a force on the distal bearing 23, in order to push the distal end of the worm 18 in the direction X1 towards the wheel 19. The case 17a comprises a housing 17b in which are disposed the worm 18 and the bearings 22, 23. The housing 17b includes a substantially cylindrical distal portion 17c to accommodate the spring 30 surrounding the distal bearing 23. The bearings 22, 23 are for example of the ball bearing type.

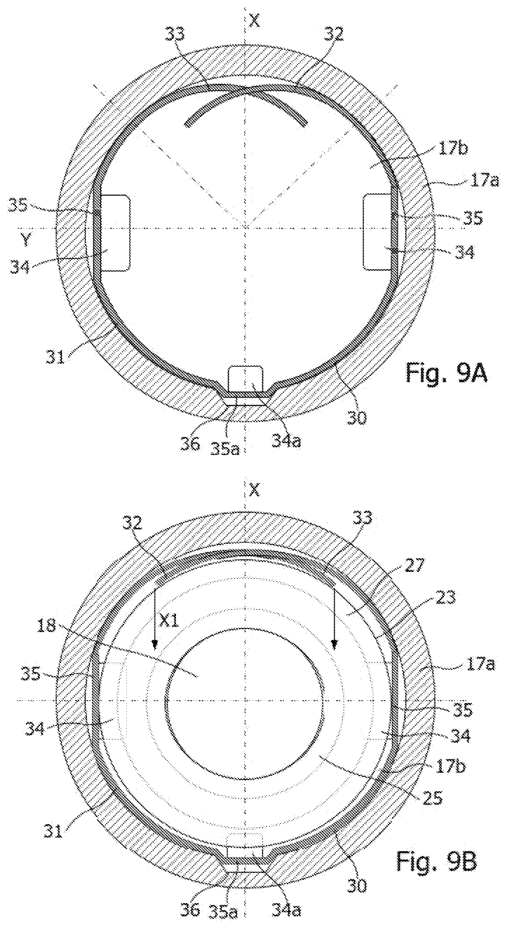

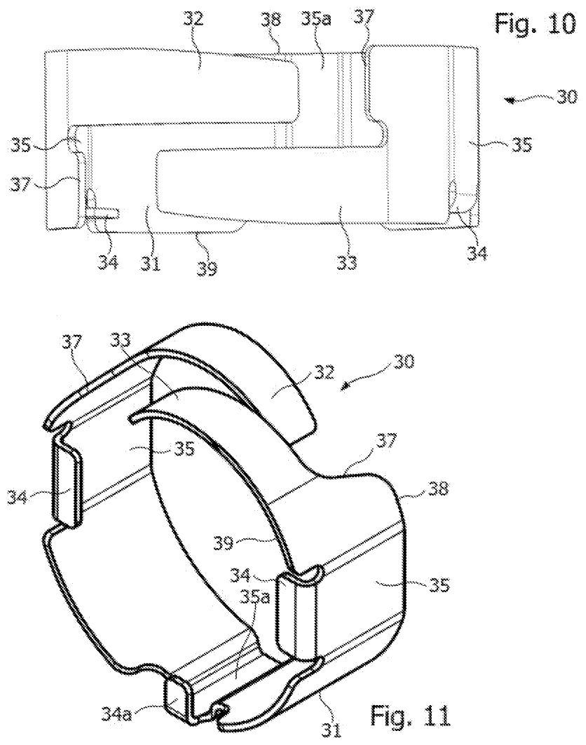

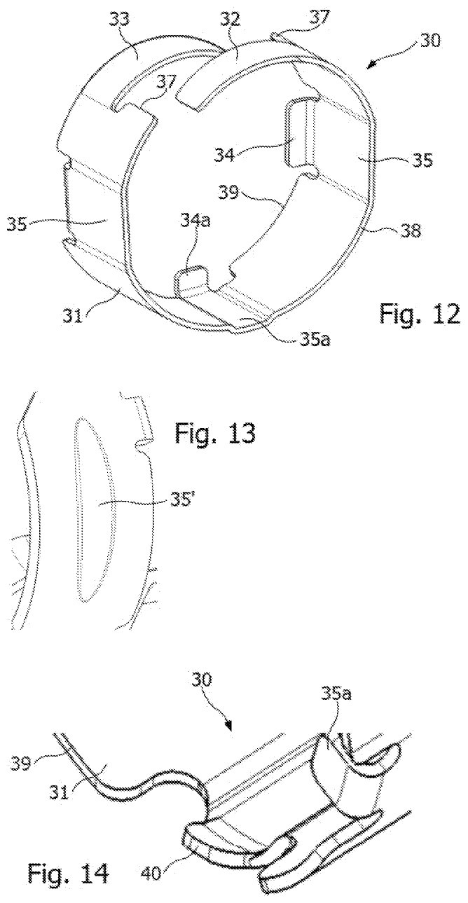

FIGS. 9A, 9B represent the spring 30 in case 17a, FIG. 9B further shows the bearing 23 and worm 18. FIGS. 10 to 12 represent the spring alone, according to one embodiment. In FIGS. 9 to 12, the spring 30 has the shape of a collar, generally cylindrical, open between two generating lines of the cylindrical shape, comprising an open annular portion 31, that is to say extending over an annular sector smaller than 360°, for example comprised between 240° and 300°, for example equal to 270° (plus or minus 10%).

The annular portion 31 comprises a proximal annular edge 38, a distal annular edge 39 and side ends 37 facing each other. Each side end 37 is partly extended by an elastic curved blade 32, 33. The blades 32, 33 have a width lower than half the height of the spring and extend over a length lower than the distance between the longitudinal edges 37, so as to close the cylindrical shape and to intersect for example at mid-distance between the longitudinal edges 37. Thus, the spring 30 has a shape symmetrical with respect to a plane XZ passing through a longitudinal axis Z of the worm 8 and perpendicular to an axis of rotation of the wheel 19.

The distal edge 39 of the spring 30 is extended by tabs 34, 34a extending radially inwardly of the annular portion 31. The tabs 34 are provided to block the spring 30 axially on the distal bearing 23 in the proximal direction. In the distal direction, the spring 30 is blocked by the bottom of the housing 17b or a shoulder formed near thereto. Furthermore, the bearing 23 can be retained axially in the proximal direction by an annular shoulder 18a provided at the distal end of the worm 18. The bearing 23 is also blocked axially in the distal direction by its press-fitting on the worm 18. The blades 32, 33 are arranged and shaped to exert a force on the distal bearing 23 in the direction X1 towards the worm wheel 19, by bearing on the inside of the case 17a.

The tabs 34, 34a each extend a flat portion 35, 35a of the annular portion 31. The flat side parts 35 are disposed and shaped to laterally block the spring 30 in the case 17a in order to eliminate any side gap of the bearing 23 and of the worm 18, and to guide the bearing 23 in its movements along the direction X1 and the opposite direction. The annular portion 31 comprises a protrusion intended to be engaged in a recess 36 formed in the case 17a, in order to block the spring 30 in rotation (around the Z axis) in the case 17a.

According to one embodiment, this protrusion is formed by a U-folding of the strip forming the annular portion 31, so as to move the flat portion 35a radially outwardly of the annular portion (FIGS. 9A, 9B). The recess 36 in the case 17a can also axially block the spring 30 in the distal direction.

In this way, the spring 30 is fixed relative to the case 17a. The flat portion 35a is for example located in a position radially opposite to the intersection area of the blades 32, 33. The flat portion 35a also forms an index making it possible to define the direction of the forces exerted by the blades 32, 33 on the bearing 23, relative to the case 17a. The direction of the forces exerted by the blades 32, 33 can be finely adjusted by adjusting the position, relative to the direction X1, of the shape 35a on the annular portion 31 of the spring 30, which can be manufactured for example by stamping and/or or bending of a spring blade. It should be noted that the flat portion 35a is not in contact with the case, and only the side portions connecting the flat portion 35a to the remainder of the spring define the angular position of the spring 30 around the Z-axis.

According to one embodiment, the flat portions 35 are stiffened by the formation of folds. However, it should be noted that the extension of the flat portions 35, 35a by bent tabs contributes to stiffening these portions.

Under assistance torque, the elastic blades 32, 33 retract unfoldingly by pressing against the case 17a as the worm 18 moves in the opposite direction to the wheel 19. Thanks to this unfolding, the local deformations of the elastic blades 32, 33 are very low and therefore the risks of plastic deformation and fatigue failure of the elastic blades are minimized.

The curvature of the elastic blades 32, 33, towards the bearing 23, and their profiles with varying section along the blades are defined so as to exert forces whose intensity is defined according to the stroke. According to one embodiment, the curvature and the shape of the blades 32, 33 are defined so that the value of the exerted forces varies according to the stroke, first linearly with a slight slope, then increases more rapidly at the end of stroke. Thus the value of the exerted forces increases rapidly on approaching the abutment position of the bearing 23 in the case 17a, due to the unfolding of the blades (shortening of the lever arm). Thus, the shock noise likely to occur due to a brutal contact of the bearing 23 at the end of stroke against the case 17a is reduced.

In abutment, the radii of curvature of the outside of the bearing 23, the unfolded blades 32, 33 and of the housing in the case 17a are close. This results in contacts with well-distributed pressures, which avoids pressure stress concentrations that are too localized, which could be harmful to the service life of the spring 30 and in particular of the blades 32, 33.

According to an embodiment illustrated by FIG. 13, the flat portions 35 of the spring 30 are replaced by rectilinear ribs 35′ performing the same functions, these ribs being able to be produced by inwardly stamping the annular portion.

According to an embodiment illustrated in FIG. 14, the tab 35a of the spring 30 is replaced by a spatula-like element 40 making it possible to facilitate the mounting of the spring in the case. When mounting the spring 30, a guide is temporarily positioned in the housing of the wheel 19. This guide ensures continuity between a passage and orientation notch located at the entrance to the housing 17b and a notch located in the distal portion 36 of the housing 17b. Between these two notches is the window/intersection (mesh area) between the bore containing the worm 18 and the chamber containing the wheel 19. The spatula-like shape 40 facilitates the passages entry/guide then guide/distal portion 36.

It will clearly appear to those skilled in the art that the present invention is subject to various embodiments and various applications. In particular, the invention is not limited to the shape of the spring 30 previously described. Indeed, the spring 30 may include only one elastic blade arranged to exert on the distal bearing 23 a force in the direction of the worm wheel 19.

In addition, the spring can be held in the case by a means other than a protrusion engaged in a recess in the case. Thus, for example, the recess can be formed in the spring and the protrusion can be formed in the case.

Furthermore, the speed reducer can be used in other mechanical systems than a motor vehicle power steering system.

1. A speed reducer comprising:
a case,
a worm disposed in a housing of the case and including a proximal portion coupled to an input shaft,
a worm wheel coupled to an output shaft and arranged so as to be driven in rotation by the worm,
a proximal bearing holding the proximal portion of the worm in the housing,
a distal bearing holding a distal portion of the worm, the distal bearing being disposed in a cylindrical distal portion of the housing,
a spring held fixed in the distal portion of the housing around the distal bearing, the spring comprising at least one elastic blade disposed and shaped to bear on the case and to exert forces on the distal bearing in a direction towards the worm wheel.

2. The speed reducer according to claim 1, wherein the spring comprises a protrusion adapted to be engaged in a recess formed in the distal portion of the housing, in order to block the spring in rotation in the housing.

3. The speed reducer according to claim 2, wherein the protrusion has a U-shape extending radially outwardly of the spring.

4. The speed reducer according to claim 1, wherein the spring comprises flat side portions disposed and shaped to guide the distal bearing in the direction towards the worm wheel and in an opposite direction, and eliminating a side gap between the spring and the distal bearing.

5. The speed reducer according to claim 4, wherein the flat side portions are extended radially inwardly of the spring by tabs cooperating with the distal bearing to axially block the spring in a distal direction.

6. The speed reducer according to claim 1, wherein each elastic blade has a curvature and a variable width between its fixed end and its free end, adjusted so as to follow a curve of variation of the force exerted by the blade on the distal bearing as a function of a position of the distal bearing in the spring.

7. The speed reducer according to claim 6, wherein the curve of variation of the force exerted by each elastic blade on the distal bearing as a function of a position of the distal bearing in the spring is linear with a relatively low slope, then more rapidly increasing in the vicinity of an end of stroke of the distal bearing in the direction towards the worm wheel.

8. The speed reducer according to claim 1, wherein the spring comprises an annular portion extending over an angular sector comprised between 240° and 300°, each elastic blade having a free end and a fixed end secured to the annular portion.

9. The speed reducer according to claim 1, wherein the spring comprises two elastic blades having a width lower than a height of the spring and arranged so as to intersect in an area diametrically opposite to a contact area between the worm and the worm wheel.

10. A power steering for a motor vehicle, comprising a speed reducer coupled between an assistance motor and a rotary member of a steering system of a motor vehicle, the speed reducer being defined in claim 1.

11. The power steering according to claim 10, wherein the worm wheel of the speed reducer is secured to a steering column of the steering system.

12. The power steering according to claim 10, wherein the worm wheel of the speed reducer is secured to a pinion shaft coupled to a rack pinion of the steering system.

13. The power steering according to claim 10, wherein the worm wheel of the speed reducer is secured to a pinion shaft coupled to an additional rack pinion of the steering system.

14. The power steering according to claim 10, wherein the worm wheel of the speed reducer is secured to a force feedback steering column of a steering system without any mechanical link between a steering wheel and steered wheels of the motor vehicle.

15. The power steering according to claim 10, comprising another speed reducer provided with worm and worm wheel, the worm wheels of the speed reducer and of the other speed reducer being coupled respectively to rack pinions of the steering system.
